(19) United States
(12) Patent Application Publication
(10) Pub. No.: US 2026/0365867 A1
(43) Pub. Date: Nov. 19, 2026

(54) INKJET INK

(71) Applicant: KYOCERA DOCUMENT SOLUTIONS INC., OSAKA (JP)

(72) Inventor: NORIAKI OZAWA, OSAKA (JP)

(21) Appl. No.: 19/671,188

(22) Filed: May 7, 2026

(30) Foreign Application Priority Data
May 15, 2025 (JP) 2025-081780

(51) Int. Cl. C09D 11/322; C09D 11/38

(52) U.S. Cl. CPC C09D 11/322; C09D 11/38

(57) ABSTRACT

An inkjet ink includes: a pigment; a pigment dispersion resin having an acid value of 200 mg KOH/g or more and 300 mg KOH/g or less; a polyethyleneimine having a number average molecular weight of 600 or more and 1,800 or less; a moisturizing agent including at least one of 3-methyl-1,5-pentanediol or 1,2-pentanediol; and water.

### CROSS-REFERENCE TO RELATED PATENT APPLICATION

This application claims the benefit of Japanese Priority Patent Application JP 2025-081780 filed on May 15, 2025, the entire contents of which are incorporated herein by reference.

### FIELD OF THE DISCLOSURE

The present disclosure relates to an inkjet ink.

### BACKGROUND OF THE DISCLOSURE

A technology has been known in which a pre-treatment liquid is applied onto a recording medium before forming an image with an inkjet ink to enhance the density of the image formed on the recording medium with the inkjet ink. As a pre-treatment liquid, one in which an inorganic salt for promoting agglomeration of pigments on the recording medium is blended has been known.

### SUMMARY OF THE DISCLOSURE

An inkjet ink according to an embodiment of the present disclosure includes: a pigment; a pigment dispersion resin having an acid value of 200 mg KOH/g or more and 300 mg KOH/g or less; a polyethyleneimine having a number average molecular weight of 600 or more and 1,800 or less; a moisturizing agent including at least one of 3-methyl-1,5-pentanediol or 1,2-pentanediol; and water.

### DETAILED DESCRIPTION OF THE EXEMPLARY EMBODIMENTS

However, in the technology in which a pre-treatment liquid is applied onto a recording medium before forming an image with an inkjet ink, it is necessary to newly introduce a device for applying the pre-treatment liquid and the time necessary for the recording medium to dry increases, for example. Further, when the inorganic salt used in the pre-treatment liquid is blended in an inkjet ink, the progression of agglomeration of pigments over time makes it difficult to ensure preservation stability.

In view of the circumstances as described above, it is an object of the present disclosure to provide an inkjet ink capable of achieving both image density and preservation stability.

An embodiment of the present disclosure will be described.

### [Configuration of Ink]

### (Schematic Configuration)

An inkjet ink according to an embodiment of the present disclosure (hereinafter, also referred to simply as an “ink”) includes a pigment, a pigment dispersion resin, a polyethyleneimine, a moisturizing agent, and water. The ink according to this embodiment is a water-based ink that is ejected from a recording head of an inkjet recording apparatus onto a recording medium to record an image on the recording medium. The recording medium on which an image is to be recorded by the ink according to this embodiment includes a fiber such as a cellulose fiber. Examples of such a recording medium include plain paper, copy paper, recycled paper, thin paper, and thick paper.

In the ink according to this embodiment a polyethyleneimine is blended as an alkaline agent that promotes agglomeration of pigments by reacting with a pigment dispersion resin coating the pigment, instead of the inorganic salt commonly used. As a result, in the ink according to this embodiment, agglomeration of pigments over time is less likely to occur, achieving high preservation stability that the quality remains unchanged for a long period of time.

In the ink according to this embodiment, the pigment dispersion resin has an acid value of 200 mg KOH/g or more and 300 mg KOH/g or less and the polyethyleneimine has a number average molecular weight of 600 or more and 1,800 or less. As a result, in the ink according to this embodiment, the timing of agglomeration of pigments due to the reaction between the pigment dispersion resin and the polyethyleneimine can be controlled. That is, in the ink according to this embodiment, the reaction between the pigment dispersion resin and the polyethyleneimine does not proceed during preservation, and the reaction between the pigment dispersion resin and the polyethyleneimine proceeds during the process of water evaporation on the recording medium.

For this reason, in the ink according to this embodiment, quality degradation due to agglomeration of pigments over time is less likely to occur during preservation, and high image density can be achieved by agglomeration of pigments on the recording medium. Therefore, the ink according to this embodiment is capable of achieving both image density and preservation stability.

Further, in the ink according to this embodiment, at least one of 3-methyl-1,5-pentanediol or 1,2-pentanediol, which is a diol-based solvent, is used as a moisturizing agent. As a result, in the ink according to this embodiment, agglomeration of pigments can be promoted while efficiently retaining the pigment near the surface of the recording medium. This allows the ink according to this embodiment to be more likely to achieve higher image density.

Details of each component of the ink according to this embodiment will be described below.

### (Pigment)

The ink according to this embodiment includes a pigment as a coloring agent from the viewpoint of improving color mixing resistance and water resistance in images recorded on the recording medium. The pigment may be either an inorganic pigment or an organic pigment. Further, as the pigment, these may be combined with an extender pigment, as necessary.

Specific examples of the inorganic pigment that can be used in the ink according to this embodiment include carbon black and a metal oxide. In particular, in the case of a black ink, carbon black is favorable. Examples of the carbon black include furnace black, thermal lamp black, acetylene black, and channel black.

Specific examples of the organic pigment that can be used in the ink according to this embodiment include an azo pigment, a diazo pigment, a phthalocyanine pigment, a quinacridone pigment, an isoindolinone pigment, a dioxazine pigment, a perylene pigment, a perinone pigment, a thioindigo pigment, an anthraquinone pigment, and a quinophthalone pigment.

In the ink according to this embodiment, the hue is not particularly limited, and a colored pigment of any of colors such as yellow, magenta, cyan, blue, red, orange, and green can be used. Favorable specific examples of the colored pigment include C.I. Pigment Yellow, C.I. Pigment Red, C.I. Pigment Orange, C.I. Pigment Violet, C.I. Pigment Blue, and C.I. Pigment Green. In the ink according to this embodiment, one or two or more selected from these colored pigments can be used as the pigment.

### (Pigment Dispersion Resin)

The pigment dispersion resin is favorably fine particles of a resin having a molecular weight of several ten thousand from the viewpoint of improving the quality of the image to be formed on the recording medium. Further, the acid value of the pigment dispersion resin is favorably 150 mg KOH/g or more and 300 mg KOH/g or less. Note that the acid value of the pigment dispersion resin is obtained by measurement according to JIS K 0070:1992 (Test methods for acid value, saponification value, ester value, iodine value, hydroxyl value and unsaponifiable matter of chemical products).

As the pigment dispersion resin, a known pigment dispersion resin can be appropriately selected and used. The pigment dispersion resin may be either a random polymer or a block polymer. Specific examples of the pigment dispersion resin include polyester, polyurethane, (meth)acrylic acid polymer, a styrene-(meth)acrylic acid copolymer, a styrene-maleic acid copolymer, a styrene-maleic acid half ester copolymer, a vinyl naphthalene-(meth)acrylic acid copolymer, and a vinyl naphthalene-maleic acid copolymer. The styrene-(meth)acrylic acid copolymer is a resin including a unit derived from styrene and a unit derived from (meth)acrylic acid, (meth)acrylic acid ester, or methacrylic acid ester. Examples of the styrene-(meth)acrylic acid copolymer include a styrene-(meth)acrylic acid-(meth)acrylic acid alkyl ester copolymer, a styrene-methacrylic acid-methacrylic acid alkyl ester-(meth)acrylic acid alkyl ester copolymer, a styrene-(meth)acrylic acid copolymer, a styrene-maleic acid-(meth)acrylic acid alkyl ester copolymer, a styrene-methacrylic acid copolymer, and a styrene-methacrylic acid alkyl ester copolymer. Of these pigment dispersion resins, a styrene-(meth)acrylic acid copolymer is favorable because it is easy to prepare and has an excellent dispersion effect of the quinacridone pigment.

In the ink according to this embodiment, in order to sufficiently achieve the above effect of the pigment dispersion resin, the content of the pigment dispersion resin is favorably 0.5 mass % or more. Further, in the ink according to this embodiment, in order to achieve high dispersion stability, the content of the pigment dispersion resin is favorably 7 mass % or less.

### (Alkaline Agent)

In the ink according to this embodiment, a polyethyleneimine having a number average molecular weight of 600 or more and 1,800 or less is blended as an alkaline agent. In the ink according to this embodiment, the content of the polyethyleneimine is favorably 2 mass % or more and 10 mass % or less. In the ink according to this embodiment, by setting the content of the polyethyleneimine to 2 mass % or more, the effect of agglomerating pigments on the recording medium is sufficiently achieved. Further, in the ink according to this embodiment, by setting the content of the polyethyleneimine to 10 mass % or less, the decrease in preservation stability due to the reaction between the polyethyleneimine and the resin is less likely to occur.

### (Moisturizing Agent)

In the ink according to this embodiment, at least one of 3-methyl-1,5-pentanediol or 1,2-pentanediol is blended as a moisturizing agent. In the ink according to this embodiment, the total content of 3-methyl-1,5-pentanediol and 1,2-pentanediol is favorably 20 mass % or more and 50 mass % or less. In the ink according to this embodiment, by setting the total content of 3-methyl-1,5-pentanediol and 1,2-pentanediol to 20 mass % or more, the effect of promoting agglomeration of pigments while efficiently retaining the pigment near the surface of the recording medium is achieved well. Further, in the ink according to this embodiment, by setting the total content of 3-methyl-1,5-pentanediol and 1,2-pentanediol to 50 mass % or less, favorable permeability is achieved, and high image density is more likely to be achieved.

### (Water)

In the ink according to this embodiment, ion exchanged water, purified water, distilled water, or the like can be used as water. In the ink according to this embodiment, the content of water is favorably 30 mass % or more and 60 mass % or less from the viewpoints of dryness and ejection reliability.

### (Other Components)

In the ink according to this embodiment, components other than the above may be blended as necessary. For example, in the ink according to this embodiment, a surfactant may be blended. The surfactant has the effect of enhancing the wettability of the ink on a recording medium and the effect of enhancing the compatibility and dispersion stability of each component included in the ink. Examples of the surfactant blended in the ink according to this embodiment include an anionic surfactant, a cationic surfactant, a non-ionic surfactant, and an amphoteric surfactant. The surfactant is favorably a non-ionic surfactant. The non-ionic surfactant is favorably a surfactant having an acetylene bond, more favorably a surfactant having an acetylene glycol structure or an acetylene alcohol structure.

Further, in the ink according to this embodiment, various additives such as a penetrating agent, a dissolution stabilizer, an anti-drying agent, an antioxidant, a viscosity adjustor, a pH adjuster, a neutralizer, and an antifungal agent may be blended as necessary in addition to the surfactant.

### EXAMPLE

Inks were prepared and evaluated as Examples of the present disclosure.

### (Preparation of Ink)

First, a pigment dispersion liquid in which a pigment was dispersed in water was prepared. The pigment dispersion liquid was prepared by blending a pigment, a pigment dispersion resin, sodium hydroxide, SURFYNOL 420, and water.

Sodium hydroxide was blended as a neutralizer for neutralizing the pigment dispersion resin. SURFYNOL 420 is blended as a dispersant for enhancing the dispersibility of the pigment in the solvent, and is a nonionic surfactant manufactured by Nissin Chemical Co., Ltd. In each Example, Pigment Blue 15:3 (“LIONOL BLUEFG-7351” manufactured by Toyocolor Co., Ltd.) was used as the pigment and ion exchanged water was used as water.

The pigment dispersion liquid was prepared by mixing the above components by wet dispersion using a media-type wet disperser. Examples of the media-type wet disperser include a wet disperser (more specifically, “Nano Grain Mill” manufactured by ASADA IRON WORKS. CO., LTD., “MSC mill” manufactured by NIPPON COKE & ENGINEERING. CO., LTD., “DYNO (registered trademark)-MILL” manufactured by Shinmaru Enterprises Corporation, and the like).

In the wet dispersion using the media-type wet disperser, media (zirconia beads having a diameter of 0.5 mm) were set in a vessel, and the ejection rate was controlled to be 200 to 600 g/min such that the average particle diameter of the pigment dispersion in which the dispersant had adhered to the pigment dispersed in water was 90 to 110 nm. For measurement of the particle size distributions of the pigment dispersion, a diluted solution obtained by diluting the pigment dispersion liquid 300 times with ion exchanged water was measured using “Zetasizer Nano” manufactured by Sysmex Corporation.

Next, ink samples according to Examples were prepared. The ink samples according to Examples were prepared by blending the above pigment dispersion liquid, SURFYNOL 104, moisturizing agent, polyethyleneimine, and water. SURFYNOL 104 is a nonionic surfactant manufactured by Nissin Chemical Co., Ltd.

In the preparation of the ink samples according to Examples, the pigment dispersion liquid, SURFYNOL 104, the moisturizing agent, the polyethyleneimine, and water were added in this order while stirring the solvent using a stirrer. Further, each ink after stirring was filtered using a filter having a pore size of φ5 μm to remove foreign substances, dirt, coarse particles, and the like.

### (Evaluation of Ink)

For the ink samples according to Examples, image density and preservation stability were evaluated.

### Method of Evaluating Image Density

In the evaluation of image density, an inkjet recording apparatus (line type, manufactured by KYOCERA Document Solutions Inc.) was used as a tester. In the tester, the drive voltage was set such that the amount of ink to be ejected from one recording head was 12 pL. Using the tester, a solid image of 10 cm×10 cm was formed on a recording medium (“Vitality” manufactured by Xerox Corporation). The recording medium on which the image was formed was left to stand for 12 hours, and then, the image density of the solid image formed on the recording medium was measured using a spectrodensitometer (FD-5, manufactured by Konica Minolta, Inc.). The image density was evaluated in accordance with the following criteria A and B. Inks with the evaluation of A for the image density are evaluated to “Pass,” and inks with the evaluation of B are evaluated to “Fail.”
A: 1.4 or more
B: less than 1.4.

### Method of Evaluating Preservation Stability

In the evaluation of preservation stability, the particle size distribution of the pigment dispersion was measured using “Zetasizer Nano” manufactured by Sysmex Corporation before and after the ink was allowed to stand for one week, and the change rate of the average particle diameter of the pigment dispersion was obtained. The average particle diameter of the pigment dispersion was evaluated in accordance with the following criteria A and B. Inks with the evaluation of A for preservation stability are evaluated to “Pass,” and inks with the evaluation of B are evaluated to “Fail.”
A: less than 10%
B: 10% or more

### (Samples 1 to 5)

The pigment dispersion liquid was prepared such that the composition shown in Table 1 was achieved, and ink samples 1 to 5 were prepared such that the composition shown in Table 2 was achieved. In all of the samples 1 to 5, a polyethyleneimine having a number average molecular weight of 600 (“SP-006” manufactured by NIPPON SHOKUBAI CO., LTD.) was used as an alkaline agent, a styrene-methacrylic acid copolymer was used as a pigment dispersion resin, and 3-methyl-1,5-pentanediol (MPD) was used as a moisturizing agent.

TABLE 1

| Component | Content (mass %) |
|---|---|
| Pigment | 15 |
| Pigment dispersion resin | 1.0 |
| Sodium hydroxide | 0~1.0 |
| SURFYNOL 420 | 0.5 |
| Water | Remainder |

TABLE 2

| Component | Content (mass %) |
|---|---|
| Pigment dispersion liquid | 53.3 |
| SURFYNOL 104 | 0.5 |
| MPD | 30.0 |
| Polyethyleneimine | 5.0 |
| Water | Remainder |

In the samples 1 to 5, the acid value was varied by changing the ratio of styrene to methacrylic acid (St/MAA) in the pigment dispersion resin. In the sample 1, a pigment dispersion resin having an acid value of 180 mg KOH/g by setting St/MAA to 72/28 was used. In the sample 2, a pigment dispersion resin having an acid value of 200 mg KOH/g by setting St/MAA to 61/39 was used. In the sample 3, a pigment dispersion resin having an acid value to 240 mg KOH/g by setting St/MAA to 63/37 was used. In the sample 4, a pigment dispersion resin having an acid value of 300 mg KOH/g by setting St/MAA to 54/46 was used. In the sample 5, a pigment dispersion resin having an acid value of 320 mg KOH/g by setting St/MAA to 51/49 was used.

Table 3 shows the evaluation results of image density and preservation stability for the samples 1 to 5. In all of the samples 2 to 4, the image density and the preservation stability were evaluated to “Pass.” On the other hand, in the samples 1 in which the acid value of the pigment dispersion resin was less than 200 mg KOH/g, the reactivity of the pigment dispersion resin was insufficient and the image density was evaluated to “Fail.” Further, in the sample 5 in which the acid value of the pigment dispersion resin was more than 300 mg KOH/g, the preservation stability was evaluated to “Fail.”

TABLE 3

| | Sample | | | | |
|---|---|---|---|---|---|
| | 1 | 2 | 3 | 4 | 5 |
| Pigment dispersion resin | 180 | 200 | 240 | 300 | 320 |
| Acid value (mg KOH/g) | | | | | |
| Image density | B | A | A | A | A |
| Preservation stability | A | A | A | A | B |

### (Samples 6 to 10)

The pigment dispersion liquid was prepared such that the composition shown in Table 4 was achieved, and ink samples 6 to 10 were prepared such that the composition shown in Table 5 was achieved. In all of the samples 6 to 10, a polyethyleneimine was used as an alkaline agent, a styrene-methacrylic acid copolymer having an acid value of 240 mg KOH/g was used as a pigment dispersion resin, and 3-methyl-1,5-pentanediol (MPD) was used as a moisturizing agent.

TABLE 4

| Component | Content (mass %) |
|---|---|
| Pigment | 15 |
| Pigment dispersion resin | 1.3 |
| Sodium hydroxide | 0~1.0 |
| SURFYNOL 420 | 0.5 |
| Water | Remainder |

TABLE 5

| Component | Content (mass %) |
|---|---|
| Pigment dispersion liquid | 53.3 |
| SURFYNOL 104 | 0.5 |
| MPD | 30.0 |
| Polyethyleneimine | 5.0 |
| Water | Remainder |

In the samples 6 to 10, polyethyleneimines having different number average molecular weights were used. In the sample 6, a polyethyleneimine having a number average molecular weight of 300 (“SP-003” manufactured by NIPPON SHOKUBAI CO., LTD.) was used. In the sample 7, a polyethyleneimine having a number average molecular weight of 600 (“SP-006” manufactured by NIPPON SHOKUBAI CO., LTD.) was used. In the sample 8, a polyethyleneimine having a number average molecular weight of 1,200 (“SP-012” manufactured by NIPPON SHOKUBAI CO., LTD.) was used. In the sample 9, a polyethyleneimine having a number average molecular weight of 1,800 (“SP-018” manufactured by NIPPON SHOKUBAI CO., LTD.) was used. In the sample 10, a polyethyleneimine having a number average molecular weight of 2,000 (“Polyethyleneimine, branched, M.W. 2,000” manufactured by FUJIFILM Wako Pure Chemical Corporation) was used.

Table 6 shows the evaluation results of image density and preservation stability for the samples 6 to 10. In the samples 7 to 9, the image density and the preservation stability were evaluated to “Pass.” On the other hand, in the sample 6 in which the number average molecular weight of the polyethyleneimine was less than 600, the number of reactive groups per molecule of the polyethyleneimine was insufficient and the image density was evaluated to “Fail.” Further, in the sample 10 in which the number average molecular weight of the polyethyleneimine was more than 1,800, the preservation stability was evaluated to “Fail.”

TABLE 6

| | Sample | | | | |
|---|---|---|---|---|---|
| | 6 | 7 | 8 | 9 | 10 |
| Number average molecular | 300 | 600 | 1,200 | 1,800 | 2,000 |
| weight of polyethyleneimine | | | | | |
| Image density | B | A | A | A | A |
| Preservation stability | A | A | A | A | B |

### (Samples 11 to 15)

The pigment dispersion liquid was prepared such that the composition shown in Table 7 was achieved, and ink samples 11 to 15 were prepared such that the composition shown in Table 8 was achieved. In all of the samples 11 to 15, a polyethyleneimine having a number average molecular weight of 600 (“SP-006” manufactured by NIPPON SHOKUBAI CO., LTD.) was used as an alkaline agent, and a styrene-methacrylic acid copolymer having an acid value of 240 mg KOH/g was used as a pigment dispersion resin.

TABLE 7

| Component | Content (mass %) |
|---|---|
| Pigment | 15 |
| Pigment dispersion resin | 1.3 |
| Sodium hydroxide | 0~1.0 |
| SURFYNOL 420 | 0.5 |
| Water | Remainder |

TABLE 8

| Component | Content (mass %) |
|---|---|
| Pigment dispersion liquid | 53.3 |
| SURFYNOL 104 | 0.5 |
| MPD | 30.0 |
| Polyethyleneimine | 5.0 |
| Water | Remainder |

In the samples 11 to 15, different moisturizing agents were used. In the sample 11, 1,3-butanediol (1,3-BDO), which was a hydrophilic diol (C4 diol), was used as a moisturizing agent. In the sample 12, 3-methyl-1,5-pentanediol (MPD), which was a hydrophobic diol (C6 diol), was used as a moisturizing agent. In the sample 13, 1,2-pentanediol (1,2-PDO), which was a hydrophobic diol (C5 diol), was used as a moisturizing agent. In the sample 14, diethylene glycol monoethyl ether (EDG), which was a hydrophilic glycol ether, was used as a moisturizing agent. In the sample 15, triethylene glycol monobutyl ether (BTG), which was a hydrophobic glycol ether, was used as a moisturizing agent.

Table 9 shows the evaluation results of image density and preservation stability for the samples 11 to 15. In all of the samples 12 and 13 in which a hydrophobic diol was used as a moisturizing agent, the image density and the preservation stability were evaluated to “Pass.” On the other hand, in the sample 11 in which 1,3-butanediol (1,3-BDO) was used as a moisturizing agent, the image density was evaluated to “Fail.” Further, in the sample 14 in which diethylene glycol monoethyl ether (EDG) was used as a moisturizing agent, the image density and the preservation stability were evaluated to “Fail.” In the sample 15 in which triethylene glycol monobutyl ether (BTG) was used as a moisturizing agent, the preservation stability was evaluated to “Fail.”

TABLE 9

| | Sample | | | | |
|---|---|---|---|---|---|
| | 11 | 12 | 13 | 14 | 15 |
| Type of moisturizing agent | 1,3-BDO | MPD | 1,2-PDO | EDG | BTG |
| Image density | B | A | A | B | A |
| Preservation stability | A | A | A | B | B |

It should be understood by those skilled in the art that various modifications, combinations, sub-combinations and alterations may occur depending on design requirements and other factors insofar as they are within the scope of the appended claims or the equivalents thereof.

What is claimed is:

1. An inkjet ink, comprising:
a pigment;
a pigment dispersion resin having an acid value of 200 mg KOH/g or more and 300 mg KOH/g or less;
a polyethyleneimine having a number average molecular weight of 600 or more and 1,800 or less;
a moisturizing agent including at least one of 3-methyl-1,5-pentanediol or 1,2-pentanediol; and
water.
